(19) United States
(12) Patent Application Publication
(10) Pub. No.: US 2011/0056815 A1
(43) Pub. Date: Mar. 10, 2011

(54) CAP FOR A DISPLAY OR CONTROL ELEMENT, COMPRISING A LIGHT-PERMEABLE METAL COATING, AND METHOD FOR THE PRODUCTION THEREOF

(76) Inventors: Matthias Lust, Neustadt (DE); Martin Jeitner, Ostheim (DE); Wolfgang Kuechler, Ostheim (DE)

(21) Appl. No.: 12/441,876

(22) PCT Filed: Sep. 20, 2007
(86) PCT No.: PCT/EP07/08175

§ 371 Date: Sep. 21, 2009

(30) Foreign Application Priority Data
Sep. 22, 2006 (DE) 10-2006-045-336.0
Jun. 22, 2007 (DE) 10-2007029314.5

(51) Int. Cl. H01H 9/00; B29C 45/17; B29C 55/30

(52) U.S. Cl. 200/314; 264/400; 200/313

(57) ABSTRACT

The invention relates to a cap (1) for a display and/or control element, comprising a cap member (2) for covering a light source and/or actuating a switch of an associated control element. A luminous area or projection area is embodied in the cap member (2) in such a way that a symbol (5) represented on or through the luminous area or projection area becomes visible for an operator of the control element by irradiating the symbol (5) by means of a light source located on the switch side. The cap (1) is characterized in that the luminous area or projection area encompasses a light-permeable metal coating (4) which is preferably applied using a PVD process. The invention further relates to an associated production method, a display or control element comprising said cap, and a use.

The invention concerns a cap for a display or control element, in particular a button, for example for use in a motor vehicle or in a household appliance. The cap, which is a button cap for example, has a cap member and, located in the cap member, a luminous area or projection area, which, when the cap is used and arranged as intended as part of a display or control element, is visible to the operator on account of a light source located under the cap. The luminous or projection area serves to represent an illuminated symbol that, for example, informs the operator of which device can be operated with the control element, for example the air conditioning control in a motor vehicle. In particular, the luminous area or projection area can serve to provide information on the switching state of the control element or the switching state of the devices connected to the control element, or it can serve to provide information on states of the devices standing in association with the display or control element, such as identification and function displays, in order to indicate conditions such as a problem with the device connected to the display or control element.

It is known from DE 10 2005 006 459 A1 to provide a display element made of a transparent or translucent plastic with a metal coating in part of its area by means of an adhesion promoting layer, wherein the adhesion promoting layer, which has been applied by means of PVD coating (PVD=Physical Vapor Deposition) for example, has been partially removed by laser, in order to create a symbol with backlighting. The metal coating is opaque.

DE 102 08 674 A1 also describes a method for producing a control, decorative, or display element that is coated on the front—and, moreover, galvanically coated—wherein a transparent or translucent plastic member is provided with a metal layer that is partially removed in order to create the symbol. The metal layer is not backlighted. Moreover, both methods are comparatively costly. Furthermore, the metal layer facing the observer or operator poses the problem that it is comparatively sensitive to cleaning agents and perspiration, so that the recommendation is generally made to provide an additional protective lacquer or varnish. In addition, in control or display caps produced in this way, the symbol is generally quite visible even in daylight, in particular in direct sunlight, so that under this illumination the operator cannot discern whether the symbol is actually illuminated or not, which is to say, for example, whether or not the device connected to the control element is turned on or whether or not a problem is present, for example. Since the difference between illumination for identification and for function in the display area thus is not easily recognizable under all possible lighting conditions, the conveying of information is not reliable, since incorrect information cannot be avoided under all lighting conditions. This is problematic for reasons of safety, especially in a motor vehicle.

From DE 103 37 456 A1 is known a component with a partially light-transmissive metal coating for producing an optical effect. However, this is not a backlighted control or display element.

It is thus the object of the present invention to provide a cap, in particular a button cap, for a control element or an associated control element in which the presentation of the symbol reproduced on the luminous or projection area is improved with regard to the characteristics described above, and which is also inexpensive to produce and durable. This object is attained by a cap according to claim 1, or by a display and/or control element according to claim 9 or claim 10. An associated production method and an advantageous use are the subject matter of the coordinated claims. The dependent claims each concern advantageous embodiments.

The inventive cap is intended for a display or control element and is intended for covering a pure display element, for example, or serves to cover and actuate a switch of an associated control element that is combined with a display device.

Thus, the cap forms the associated control element, for example together with at least the switch. The cap is integrated into a control or display panel or an instrument panel of a motor vehicle, for instance. For example, the associated switch is a pushbutton switch, rocker switch, momentary switch, rotary switch, etc.

According to the invention, a luminous or projection area is provided in the cap and is designed such that when illuminated by a light source located on the switch side or inner side, a symbol represented on the luminous or projection area, for example a character, word or symbol, becomes visible to a viewer or operator of the display or control element, for example the driver. The inventive cap is distinguished in that the luminous or projection area includes a light-transmissive metal coating. The degree of light transmissivity and the light source provided on the inside of the cap, or its light intensity and/or spectrum, are chosen such that, although the comparatively intense light of the light source is allowed to pass, and the viewer can thus easily recognize the illuminated symbol, the reflectivity of the metal coating ensures adequate reflection of the ambient light.

The metal coating is preferably deposited by means of a PVD (physical vapor deposition) method. In the PVD method, a fundamental distinction is made between two different methods. First, there is the more economical method of evaporation, in which metals that evaporate at low temperature are evaporated by the addition of thermal energy and are thus deposited on the surface of the button element. This method is used when vapor depositing aluminum or copper, for example. Alternatively, the sputtering of substrate material, for example stainless steel, is employed with the aid of an ionized process gas.

In this process, a process gas (generally argon) is ionized and is accelerated by means of magnetic field assistance (magnetron sputtering) onto the material to be deposited (target). Through momentum transfer of the ionized gas atoms, atoms and atom clusters are ejected from the target in the vacuum, and deposit themselves at the desired location on the surface of the cap member. Such methods are described in DE 103 37 456 A1, whose disclosure content is incorporated herein by reference.

If necessary, a pretreatment or activation of the surface to be coated can be performed to increase adhesion strength. This adhesion improvement may be necessary, for example, when the metal coating is applied to the surface of the cap member facing the operator, and this surface will be regularly touched by the operator, for example to actuate the associated switch, or will be in frequent contact with relatively aggressive cleaning fluids. The surface to be coated is pretreated or activated using these special methods for treating surfaces, for example wet chemical surface pretreatment methods such as etching and physical surface pretreatment methods such as flame treatment (pyrolysis), fluorination, corona treatment and plasma methods. The polarity or surface energy of the surface is increased by the process of activation, by which means an improved adhesion or improved wettability is achieved.

The metal coating is preferably not deposited on a surface of the cap member facing the operator or observer, but instead, for example, is deposited on the surface of the cap member facing the light source, at least in the region of the luminous or projection area, and thus is located in a place covered by the cap member. Since the metal coating thus cannot be touched by the operator, and also cannot come into contact with cleaning fluids, the metal coating is not at risk from abrasion, and no stringent requirements need be placed on its resistance to chemicals. Special surface pretreatment processes to increase adhesion can thus be advantageously eliminated.

In another advantageous embodiment, the metal coating preferably has a thickness of less than 5 μm, preferably in the range of 10 nm-50 nm. Surprisingly, it has been determined that such a range of 5 nm-50 nm in particular can provide sufficient reflection of ambient light together with sufficient transmissibility of the light from commonplace light sources such as LEDs that the “display” of the symbol in question is adequately discernible.

In an advantageous embodiment, the metal coating includes at least one metal layer chosen from at least one metal or metalloid such as Sc, Y, Ti, Zr, V, Nb, Ta, Cr, Mo, W, Mn, Fe, Co, Pd, Pt, Cu, Ag, Au, Zn, B, Al, In, TI, Si, Ge, Sn, Pb, Sb, Bi, alloys or mixed layers thereof, and/or stainless steel. The different metals or multiple different metal layers can be provided in order to achieve different optical effects, for example colored reflection. Examples of this are also disclosed in DE 103 37 456 A1.

In one embodiment, the symbol is projected on the projection area. In another advantageous embodiment, the luminous area is provided with a mask reproducing the symbol. The mask is a screen with a light transmission opening whose shape corresponds to the outline of the symbol to be represented. The inventive cap can be produced in an especially inexpensive manner with a mask. The arrangement of the mask defining the luminous symbol directly around the luminous area achieves an especially sharply contoured representation of the symbol.

In another advantageous embodiment, the mask is created by means of an opaque paint layer that is removed in sections, for example by laser processing. The inventive cap can be produced in an especially inexpensive manner by this means. Any desired symbol can be represented on the cap on account of the especially flexible options for processing by the laser.

In an advantageous embodiment of the inventive cap, the cap member, at least in the region of the luminous or projection area, preferably the entire cap member, is designed to be transparent or translucent; moreover, the mask is located on the inner side of the cap facing the switch or light source and adjacent thereto, and the metal coating is deposited between the mask and the light source. As a result of this type of arrangement, the inventive cap can be produced relatively inexpensively. The cap member or the luminous or projection area can be colored to give the represented symbol a desired color. The color of the opaque paint layer here is preferably matched to the reflective effect of the metal layer located below it, so that when the light source is switched off, clear legibility of the unilluminated symbol is ensured by a great difference in reflection and/or color effect.

According to another advantageous embodiment, a transparent or translucent paint layer is applied to the mask and the metal coating adjoins the transparent or translucent paint layer. As a result of the transparent or translucent paint layer, which is to say as a result of its distribution after application and before curing, a comparatively smooth surface is produced despite the opening(s) or recess(es) provided in the mask in the shape of the symbol and the unevenness(es) associated therewith. This facilitates the application of the metal coating and thus the production of the cap.

The invention further relates to a control element that includes the above-described cap in the above-described embodiments and with the advantages described in each case. The control element is a rotary switch, for example. Preferably the control element is a pushbutton, and the control element cap is correspondingly a pushbutton cap.

The invention further relates to a display element that includes the above-described cap in the above-described embodiments and with the advantages described in each case.

Not least on account of the very widely varying lighting conditions, the aforementioned control element especially advantageously finds application in a motor vehicle, where it is integrated into an instrument panel or a display panel, for example.

The invention further relates to a method for producing a control element cap in one of the above-described embodiments. Here, in a first step the transparent or translucent cap member is produced from polycarbonate, for example Lexan®, in an injection molding or deep drawing process. In a subsequent, second step, the opaque paint that can be processed with the laser is applied to the inner side of the cap member facing the switch or light source of the display or control element. In a subsequent, third step, the opaque paint is processed with the laser to produce the mask reproducing the symbol, in order to produce a mask. The inner side of the cap member, which is to say the side of the cap member facing the light source or the switch, remains sealed off in a light-tight manner except for the opening of the mask. In a fourth step, the mask is coated with a transparent or translucent paint in order to level the surface. In a fifth step, the metal coating is deposited onto the transparent or translucent paint by means of a PVD method. In an optional, sixth step, the cap member is coated on the side facing the operator with a transparent protective paint.

In the attached drawing, a preferred embodiment of the inventive control element cap is shown, without limiting the invention thereto, wherein

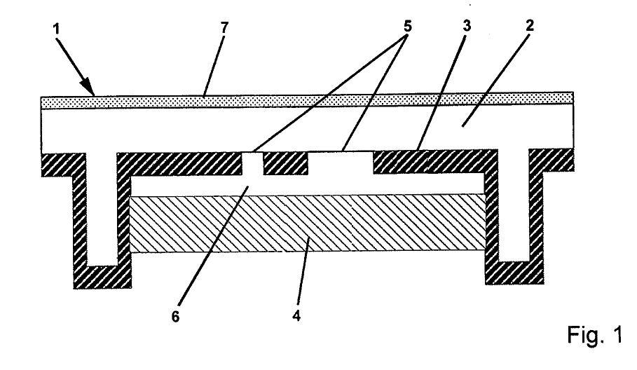

FIG. 1 shows a schematic sectional side view of the inventive display or control element cap. Since the drawing is merely for illustrative purposes, the drawing is not true to scale.

FIG. 1 shows an inventive display or control element cap, which is labeled in general as 1. The cap 1 comprises a transparent and/or translucent cap member 2 of polycarbonate, for example Lexan®, which is produced by an injection-molding or deep-drawing process. An opaque paint 3 is deposited on the inner side of the cap member 2 (the lower side of the cap member 2) facing the switch or the light source. The paint 3 has been processed with the laser to create a mask reproducing the symbol 5. The underside of the paint or of the mask 3 is coated with a transparent or translucent paint 6 that compensates for the unevenness in the opaque paint 3 created by the laser processing. A metal coating 4 is deposited by means of a PVD method on the paint 6. As explained above, the thickness shown in no way corresponds to the actual relationships. The cap member 2 is coated on the side facing the operator with a transparent, for example high gloss, protective paint 7. In the installed state, a light source that is not shown is located under the button member. Light from this light source passes through the light-transmissive metal coating 4, passes through the translucent or transparent paint 6 and causes the symbol 5 to illuminate on account of the mask 3 formed by the opaque paint. This symbol is visible from the operator side through the transparent protective paint 7 and the translucent or transparent cap member 2. When the light source is switched off, the symbol 5 is not visible at all on account of the reflecting metallic effect of the metal coating 4 with respect to light incident from the operator side.

Alternatively, it is possible and conceivable in accordance with the invention to create the mask 3 from a paint layer 3 applied by means of a printing method, in particular by means of a pad printing method, so that laser processing can be omitted. Another alternative is the insertion of film printed with a paint layer 3 in the cap member 2, wherein the film can be glued into the cap member 2 with no air gap between the paint layer or film and the cap member 2, or can be inserted into the cap member 2 with a very small air gap. The metal coating 4, which an be applied by means of the PVD method, can subsequently be applied to the film inserted into the cap member 2. To protect the PVD layer, it can alternatively be protected with a clear paint layer.

1. Cap for a display and/or control element, comprising:
a cap member for covering a light source and/or for actuating a switch of an associated control element,
wherein a luminous or projection area in the cap member is designed such that a symbol represented on or through the luminous or projection area becomes visible for an operator of the control element as a result of illumination of a light source located on the switch side, and
wherein the luminous or projection area includes a light transmissive metal coating (I) preferably deposited by a PVD method.

2. Cap for a display and/or control element according to claim 1, wherein the metal coating is not deposited on a surface of the cap member facing the operator or observer, and is deposited on the inner surface of the cap facing the light source, at least in the region of the luminous or projection area.

3. Cap for a display and/or control element according to claim 1, wherein the metal coating is deposited on a carrier film, wherein the carrier film is introduced to the cap as an insert.

4. Cap for a display and/or control element according to claim 1, wherein the metal coating has a thickness less than 5 um.

5. Cap for a display and/or control element according to claim 1, wherein the metal coating has at least one metal layer with at least one metal or metalloid comprising Sc, Y, Ti, Zr, V, Nb, Ta, Cr, Mo, W, Mn, Fe, Co, Pd, Pt, Cu, Ag, Zn, B, Al, In, Tl, Si, Ge, Sn, Pb, Sb, Bi, alloys or mixed layers thereof, and/or stainless steel.

6. Cap for a display and/or control element according to claim 1, wherein the symbol is projected on the projection area or the luminous area is provided with a mask reproducing the symbol.

7. Cap for a display and/or control element according to claim 6, wherein the mask is produced by means of an opaque paint layer that is removed in sections by laser processing.

8. Cap for a display and/or control element according to claim 6, wherein the mask is implemented by sectionwise printing with an opaque coating.

9. Cap for a display and/or control element according to claim 6, wherein the cap member is transparent or translucent in design, at least in the vicinity of the luminous or projection area, and wherein the mask is located on the inner side of the cap facing the switch and adjacent thereto.

10. Cap for a display and/or control element according to claim 6, wherein a transparent or translucent paint layer is deposited on the mask and the metal coating is deposited on the transparent or translucent paint layer.

11. Display and/or control element, comprising a control cap according to claim 1.

12. Control element according to claim 11, wherein the control element is a pushbutton and the control element cap is a pushbutton cap.

13. Display and/or control element according to claim 11, wherein the element is disposed in a motor vehicle.

14. Method for producing a cap for a display and/or control element according to claim 1, comprising:
in a first step the transparent or translucent cap member is produced from polycarbonate, in an injection molding or deep drawing process;
in a second step the paint is deposited on the inner side of the cap member facing the light source;
in a third step, the opaque paint is removed with the laser to create the mask reproducing the symbol;
in the fourth step the paint or mask is coated with a transparent or translucent paint; and
in a fifth step, the metal coating is deposited by means of a PVD method on the transparent or translucent paint; and
in an optional sixth step, the cap member is coated on the side facing the operator with a transparent protective paint.

15. Method for producing a cap for a display and/or control element according to claim 14, wherein a transparent paint layer is deposited on the metal coating-on the side facing the control component.

16. Method for producing a cap for a display and/or control element according to claim 14, wherein the mask is deposited on the cap member by means of a printing method
